(19) United States
(12) Patent Application Publication
(10) Pub. No.: US 2025/0171286 A1
(43) Pub. Date: May 29, 2025

(54) LIFT VEHICLE DRIVE SYSTEM

(71) Applicant: Moog Inc., East Aurora, NY (US)

(72) Inventors: Greg Semrau, Amherst, NY (US); Laxman Kulkarni, Bangalore (IN); Arun Sunkad, Bangalore (IN); Michael C. Baker, Gretton (GB); Paul A. Kapaun, Orchard Park, NY (US)

(21) Appl. No.: 18/842,487

(22) PCT Filed: Mar. 1, 2023
(86) PCT No.: PCT/US2023/014307

§ 371 Date: Aug. 29, 2024

Related U.S. Application Data
(60) Provisional application No. 63/316,248, filed on Mar. 3, 2022.
(60) Provisional application No. 63/445,936, filed on Feb. 15, 2023.

(51) Int. Cl. B66F 9/075; B60K 17/22; B66F 11/04

(52) U.S. Cl. CPC B66F 9/07586; B66F 9/07572; B66F 11/04; B66F 11/042; B60K 17/22

(57) ABSTRACT

A lift vehicle comprising a carriage propelled by a drive wheel system having a drive wheel rotatable about a drive axis relative to the carriage, a lift structure connected to and supporting a load carrying frame and configured to raise and lower the frame relative to the carriage, a lever linkage connected to and supporting a traction load component of the lift vehicle, the linkage coupled to the carriage at a pivot connection and coupled to the drive wheel at a drive wheel connection, the linkage rotatable about a pivot axis relative to the carriage at the pivot connection and the pivot axis offset from the drive axis by a pivot-to-drive offset distance, the traction load component supported on the linkage a pivot-to-load offset distance from the pivot axis, and the drive axis configured to rotate relative to the carriage about the pivot axis to engage a travel surface.

### TECHNICAL FIELD

The presently disclosed subject matter relates generally to aerial lift vehicles, and more particularly to an aerial lift vehicle drive system.

### BACKGROUND

Vertical mast lifts are a type of aerial lift or work platform designed to allow working access to high reaching tasks while allowing for tight fitting access and a small space footprint. Construction and maintenance jobs often require access to confined spaces, such as doorways, stairways, auditoriums, alley ways, high traffic urban areas, and similar spaces that are hard to access. Vertical mast lifts are used to meet such high reaching work access.

Mast lifts know in the art generally include a wheeled base or carriage having a drive wheel system for propelling the base or carriage, a platform having a basket for supporting a person, and a lift mechanism for raising and lowering the platform relative to the base.

### BRIEF SUMMARY

With parenthetical reference to corresponding parts, portions, or surfaces of the disclosed embodiment, merely for the purposes of illustration and not by way of limitation, the present disclosure provides a lift vehicle (15, 115, 215) comprising: a carriage (20, 220); a drive wheel system (40) operatively configured to propel the carriage; the drive wheel system comprising at least a first drive wheel (42) orientated about a drive axis (43) and operatively configured to rotate about the drive axis relative to the carriage; a load carrying frame (30); a lift structure (31) connected to and supporting the load carrying frame and operatively configured to raise and lower the load carrying frame vertically (18) relative to the carriage; a lever linkage (50, 150, 250) connected to and supporting a traction load component (31, 170) of the lift vehicle; the lever linkage coupled to the carriage at a pivot connection (34, 35, 238, 239) and operatively configured to rotate about a pivot axis (54, 284) relative to the carriage; the lever linkage coupled to the first drive wheel at a first drive wheel connection (46, 246); the pivot axis offset from the drive axis by a pivot-to-drive offset distance (D2, D15); the traction load component supported on the lever linkage a pivot-to-load offset distance (D1, D10, D18) from the pivot axis; and the drive axis operatively configured to rotate relative to the carriage about the pivot axis to engage a travel surface (16).

The drive system may comprise a second drive wheel (41) orientated about the drive axis and the lever linkage may be coupled to the second drive wheel at a second drive wheel connection (47, 247). The first drive wheel may be driven by a first traction drive (44), the second drive wheel may be driven by a second traction drive (45), the first and second drive wheels may be operatively configured to be driven independently of each other by the first and second traction drives, respectively, and the drive wheel system may be operatively configured to steer the carriage.

The carriage may comprise a plurality of unpowered support wheels (21, 22, 23, 24). The plurality of unpowered support wheels may comprise first and second front support wheels (21, 22) laterally (17) offset (D6) from each other relative to the carriage and first and second rear support wheels (23, 24) laterally offset (D6) from each other relative to the carriage. The first and second front support wheels (21, 22) may be longitudinally (19) offset (D4) from the first and second rear support wheels (23, 24) relative to the carriage. The drive axis of the first and second drive wheels may be disposed longitudinally between the first and second front support wheels and the first and second rear support wheels relative to the carriage. Each of the plurality of support wheels may comprise a caster orientated about a swivel axis (36) and operatively configured to rotate about the swivel axis relative to the carriage. The swivel axis may be perpendicular to the drive axis.

The pivot connection may comprise a first pin joint connection (34, 238) having a first clevis pin (55, 255), the carriage may comprise a first clevis (32, 236), the lever linkage may comprise a first pin opening (56, 286) configured to receive the first clevis pin, and the first clevis pin may be orientated about the pivot axis and may extend between the first clevis of the carriage and the first pin opening of the lever linkage, such that the lever linkage is rotationally connected about the pivot axis to the carriage by the first pin joint connection. The pivot connection may comprise a second pin joint connection (35, 239) having a second clevis pin, the carriage may comprise a second clevis (33, 237), the lever linkage may comprise a second pin opening (57, 287) configured to receive the second clevis pin, and the second clevis pin may be orientated about the pivot axis and may extend between the second clevis of the carriage and the second pin opening of the lever linkage, such that the lever linkage is rotationally connected about the pivot axis to the carriage by the second pin joint connection.

The lever linkage may comprise a solid unitary member having a deck plate (51, 151) supporting the traction load component.

The lift vehicle may comprise: a first link (281) coupled to the carriage at the pivot connection and operatively configured to rotate about the pivot axis relative to the carriage; the first linkage coupled to the first drive wheel at the first drive wheel connection; a second link (251) supporting the traction load component of the lift vehicle; the second link coupled to the carriage at a second pivot connection and operatively configured to rotate about a second pivot axis relative to the carriage; the second link coupled to the first link at a link connection (292, 293); the second pivot axis offset from the drive axis by a second pivot-to-drive offset distance (D16); the traction load component supported by the first link a second pivot-to-load offset distance (D11) from the second pivot axis; and wherein a traction part (F11, F12) of the traction load component is operatively transferred from the second link to the first link via the link connection.

The link connection may comprise a low friction motion translating connection operatively configured to transfer the traction part of the traction load component from the second link to the first link. The first link may comprise separate first and second traction link arms (282, 283); the pivot connection may comprise first and second traction pivot connections (238, 239); and the first and second traction link arms may be coupled to the carriage at the first and second traction pivot connections, respectively, and may be operatively configured to rotate about the pivot axis relative to the carriage. The second link may comprise separate first and second support link arms (252, 253); the second pivot connection may comprise first and second support pivot connections (234, 235); and the first and second support link arms may be coupled to the carriage at the first and second support pivot connections, respectively, and may be operatively configured to rotate about the second pivot axis relative to the carriage.

The first and second traction pivot connections may comprise first and second traction pin joint connections having first and second traction clevis pins (255), respectively; the carriage may comprise first and second traction clevises (236, 237); the first and second traction link arms may comprise first and second traction pin openings (286, 287) configured to receive the first and second traction clevis pins, respectively; the first and second traction clevis pins may be orientated about the pivot axis and may extend between the first and second traction clevises of the carriage and the first and second traction pin openings of the first and second traction link arms, respectively, such that the first link is rotationally connected about the pivot axis to the carriage by the first and second traction pin joint connections; the first and second support pivot connections may comprise first and second support pin joint connections having first and second support clevis pins (255), respectively; the carriage may comprise first and second support clevises (232, 233); the first and second support link arms may comprise first and second support pin openings (256, 257) configured to receive the first and second support clevis pins, respectively; and the first and second support clevis pins may be orientated about the second pivot axis and may extend between the first and second support clevises of the carriage and the first and second support pin openings of the first and second support link arms, respectively, such that the second link is rotationally connected about the second pivot axis to the carriage by the first and second support pin joint connections.

The first drive wheel may comprise a first drive shaft, the first traction link arm may comprise a first drive shaft opening (288) configured to receive the first drive shaft, and the first drive shaft may be orientated about the drive axis and may extend between the first drive wheel and the first drive shaft opening of the first traction link arm, such that the first drive wheel is rotationally connected about the drive axis to the first traction link arm by the first drive wheel connection (246); and the drive system may comprise a second drive wheel (41) orientated about the drive axis, the second traction link arm may be coupled to the second drive wheel at a second drive wheel connection (247), the second drive wheel may comprise a second drive shaft, the second traction link arm may comprise a second drive shaft opening (289) configured to receive the second drive shaft, and the second drive shaft may be orientated about the drive axis and may extend between the second drive wheel and the second drive shaft opening of the second traction link arm, such that the second drive wheel is rotationally connected about the drive axis to the second traction link arm by the second drive wheel connection (247). The first drive wheel may be driven by a first traction drive (44) supported by the first traction link arm, the second drive wheel may be driven by a second traction drive (45) supported by the second traction link arm, the first and second drive wheels may be operatively configured to be driven independently of each other by the first and second traction drives, respectively, and the drive wheel system may be operatively configured to steer the carriage via the lever linkage

The first drive wheel (42) may comprise a first drive shaft, the lever linkage may comprise a first drive shaft opening (58, 288) configured to receive the first drive shaft, and the first drive shaft may be orientated about the drive axis and may extend between the first drive wheel and the first drive shaft opening of the lever linkage, such that the first drive wheel is rotationally connected about the drive axis to the lever linkage by the first drive wheel connection. The drive system may comprise a second drive wheel (42) orientated about the drive axis, the lever linkage may be coupled to the second drive wheel at a second drive wheel connection (47, 247), the second drive wheel may comprise a second drive shaft, the lever linkage may comprise a second drive shaft opening (59, 289) configured to receive the second drive shaft, and the second drive shaft may be orientated about the drive axis and may extend between the second drive wheel and the second drive shaft opening of the lever linkage, such that the second drive wheel is rotationally connected about the drive axis to the lever linkage by the second drive wheel connection. The first drive wheel may be driven by a first traction drive (44) supported by the lever linkage, the second drive wheel may be driven by a second traction drive (45) supported by the lever linkage, the first and second drive wheels may be operatively configured to be driven independently of each other by the first and second traction drives, respectively, and the drive wheel system may be operatively configured to steer the carriage via the lever linkage.

The carriage may comprises a plurality of unpowered support wheels; the plurality of unpowered support wheels may comprise first and second front support wheels (21, 22) laterally offset from each other relative to the carriage and first and second rear support wheels (23, 24) laterally offset from each other relative to the carriage; the first and second front support wheels may be longitudinally offset from the first and second rear support wheels relative to the carriage by a longitudinal support wheel base distance (D4) relative to the carriage; the drive axis of the first drive wheel may be disposed longitudinally between the first and second front support wheels and the first and second rear support wheels relative to the carriage; and the pivot axis may be offset from the first and second rear support wheels by a longitudinal pivot-to-rear offset distance (D3) relative to the carriage. The pivot-to-rear offset distance (D3, D17) may be less than the support wheel base distance (D4).

The traction load component may have a traction center of mass (61) and the traction center of mass may be offset from the pivot axis the pivot-to-load offset distance (D1), and the pivot-to-load offset distance may be less than the pivot-to-drive offset distance (D2). The traction in load component may have a traction center of mass (161, 61) and the traction center of mass may be offset from the pivot axis the pivot-to-load offset distance (D10, D18), and the pivot-to-load offset distance may be greater than the pivot-to-drive offset distance (D2, D15). The traction load component may comprise the lift structure (31) and the lever linkage may comprise a solid unitary member having a deck plate (51) supporting the lift structure. The traction load component may comprise a battery (172) and the lever linkage may comprise a battery housing (171) supporting the battery. The traction load component may comprise a ballast mass (173) and the lever linkage may comprise a ballast retainer (171) supporting the ballast mass. The pivot axis and the drive axis may be substantially parallel.

The lift structure may comprise a telescoping lift mechanism and the load carrying frame may comprise an operator platform. The lift vehicle may comprise a battery supported by the carriage and the lift structure may comprise an electric battery-powered lift mechanism. The lift vehicle may comprise a battery supported by the carriage and each of the first traction drive and the second traction drive may comprise an electric battery-powered motor. The lift structure may comprise a hydraulic lift mechanism. The lift structure may comprise a telescoping lift mechanism, a jack lift mechanism, or a scissor lift mechanism.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top, front, right perspective view of an embodiment of an improved lift vehicle.

FIG. 2 is a top, front, left perspective view of the lift vehicle shown in FIG. 1.

FIG. 3 is a front view of the lift vehicle shown in FIG. 1.

FIG. 4 is a left side view of the lift vehicle shown in FIG. 1.

FIG. 5 is a bottom view of the lift vehicle shown in FIG. 1.

FIG. 6 is a partial phantom perspective view of the drive assembly of the lift vehicle shown in FIG. 1.

FIG. 7 is a perspective view of the drive linkage shown in FIG. 6.

FIG. 8 is a partial left side schematic view of the lift vehicle shown in FIG. 1 on a flat travel surface.

FIG. 9 is a schematic view of the lift vehicle shown in FIG. 8 transitioning from a flat travel surface to an ascending sloped travel surface.

FIG. 10 is a schematic view of the lift vehicle shown in FIG. 9 transitioning from an ascending sloped travel surface to a flat travel surface.

FIG. 11 is a schematic view of the lift vehicle shown in FIG. 8 transitioning from a flat travel surface to a descending sloped travel surface.

FIG. 12 is a schematic view of the lift vehicle shown in FIG. 9 transitioning from a descending sloped travel surface to a flat travel surface.

FIG. 13 is a left side schematic view of the lift vehicle shown in FIG. 1, in a raised position and transitioning from a flat travel surface to an ascending sloped travel surface.

FIG. 14 is a schematic view of the lift vehicle shown in FIG. 13 with a load analysis.

FIG. 15 is a schematic view of the lift vehicle shown in FIG. 14 with a lift structure load analysis.

FIG. 16 is a schematic view of the lift vehicle shown in FIG. 13 with a base frame load analysis.

FIG. 17 is a left side schematic view of a second embodiment of the lift vehicle shown in FIG. 1, in a raised position.

FIG. 18 is a schematic view of the lift vehicle shown in FIG. 17 with a load analysis.

FIG. 19 is a top, front, right perspective view of a third embodiment of the lift vehicle shown in FIG. 1.

FIG. 20 is a top, front, left perspective view of the lift vehicle shown in FIG. 19.

FIG. 21 is a front view of the lift vehicle shown in FIG. 19.

FIG. 22 is a left side view of the lift vehicle shown in FIG. 19.

FIG. 23 is a bottom view of the lift vehicle shown in FIG. 19.

FIG. 24 is a partial phantom perspective view of the drive assembly of the lift vehicle shown in FIG. 19.

FIG. 25 is a perspective view of the drive linkage shown in FIG. 24.

FIG. 26 is a partial left side schematic view of the lift vehicle shown in FIG. 19 on a flat travel surface and with a load analysis.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

It is to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

It is to be appreciated that the present teaching is by way of example only, not by limitation. The concepts herein are not limited to use or application with a specific system or method. Thus, although the instrumentalities described herein are for the convenience of explanation, shown and described with respect to exemplary embodiments, it will be appreciated that the principles herein may be applied equally in other types of systems and methods involving lift vehicles.

Where they are used herein, the terms “first,” “second,” and so on, do not necessarily denote any ordinal, sequential, or priority relation, but are simply used to more clearly distinguish one element or set of elements from another, unless specified otherwise.

An improved lift vehicle is provided, a first embodiment of which is generally indicated at 15. As shown, lift vehicle 15 generally includes vehicle carriage or base frame 20, operator platform 30 configured to support a person or other load, vertical lift mechanism 31 between base frame 20 and platform 30 that is configured to raise and lower platform 30 vertically 18 relative to base frame 20, drive system 40 configured to propel vehicle 15 on travel surface 16, and rigid linkage 50 between base frame 20, vertical lift mechanism 31 and drive system 40.

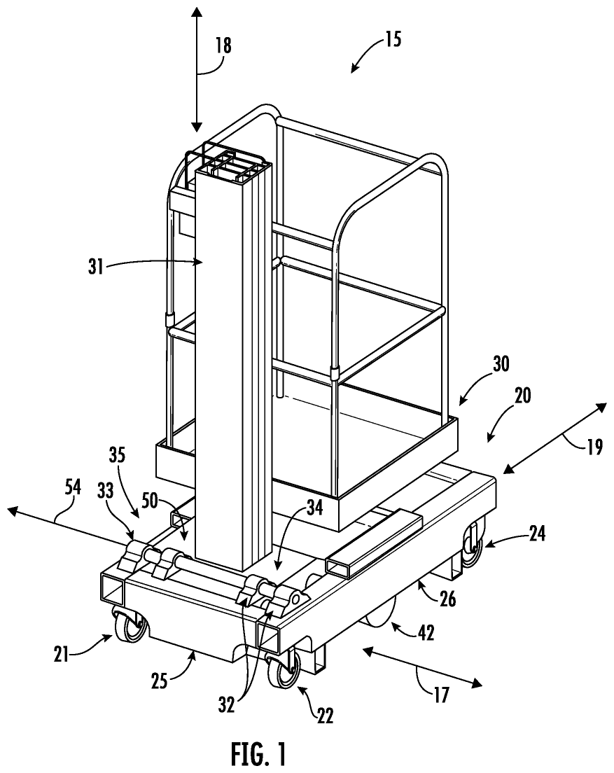

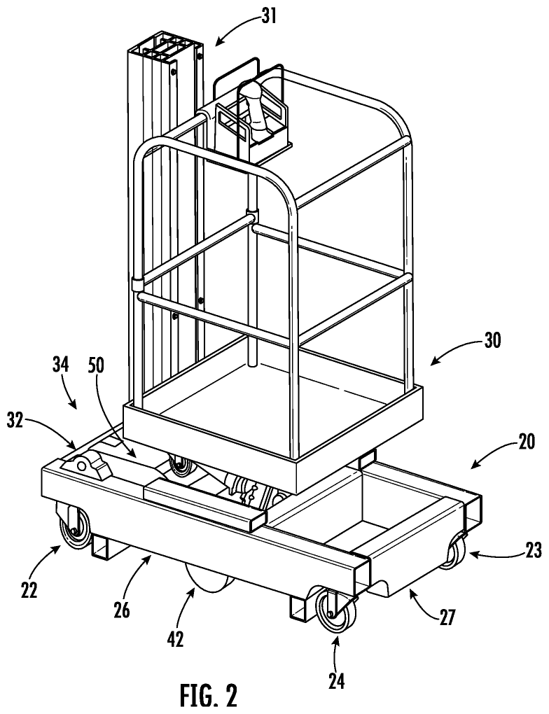

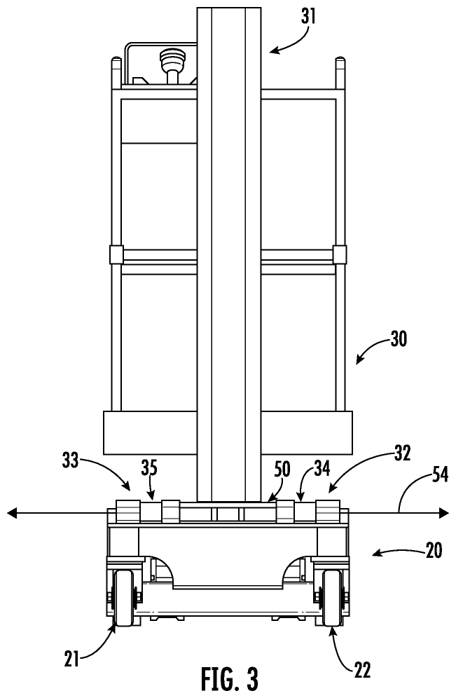

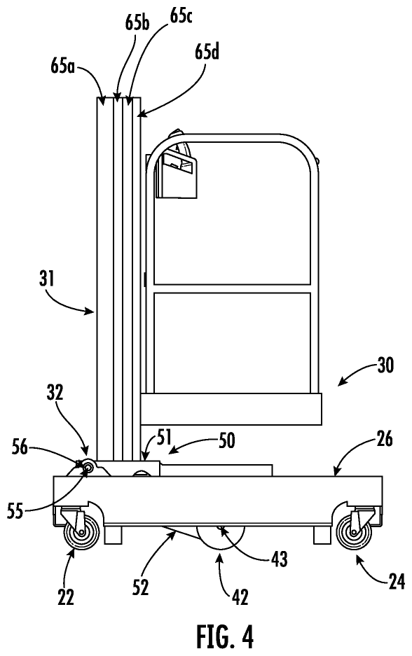

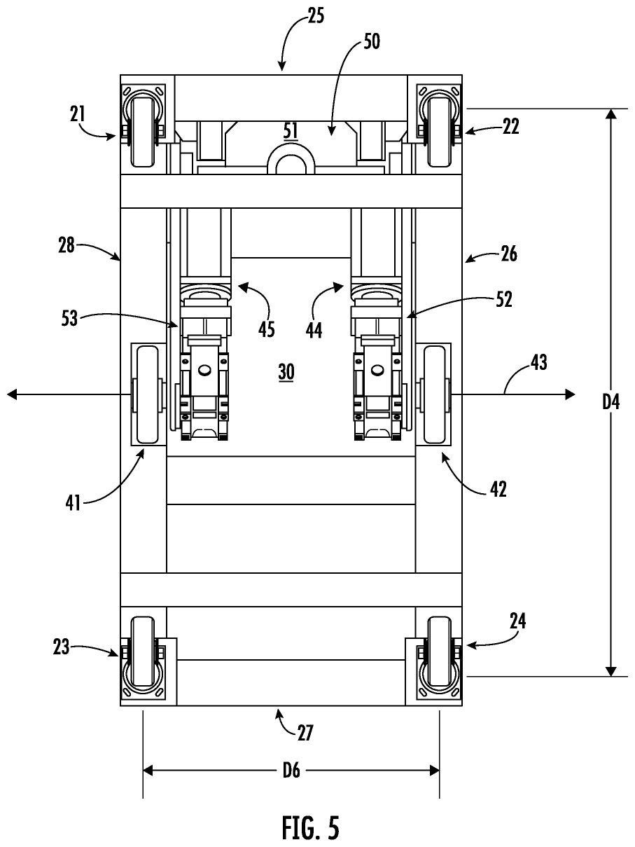

As shown in FIGS. 1-5, vehicle base frame or carriage 20 is generally formed by left longitudinally-extending side rail 26, right longitudinally-extending side rail 28 spaced laterally 17 distance D6 from and orientated parallel to side rail 26, laterally-extending front rail 25, and laterally-extending rear rail 27 spaced longitudinally 19 distance D4 from and orientated parallel to front rail 25. Base frame 20 includes left front castor wheel 22, right front castor wheel 21, left rear castor wheel 24, and right rear castor wheel 23. Wheels 21, 22, 23 and 24 are located in the four corners of carriage 20 and each swivels around its swivel axis 36 and allow carriage 20 to roll laterally 17 and longitudinally 19 on travel surface 16. Thus, front caster wheels 21 and 22 are also spaced longitudinal distance D4 from rear caster wheels 23 and 24 relative to base frame 20. Wheels 21, 22, 23 and 24 extend an equal distance below the bottom horizontal or longitudinal/lateral plane 38 of carriage 20 defined by the bottom surfaces of side and end members 25, 26, 27 and 28, and define support wheel rolling plane 37 parallel in this embodiment to longitudinal/lateral plane 38 of carriage 20. Wheels 21, 22, 23 and 24 are all unpowered.

Operator platform 30 is mounted on telescoping vertical lift mechanism 31. In this embodiment, platform 30 includes a basket and an operator controller and is configured to support a person such that lift 15 may be operated to raise or lower the operator relative to carriage 20. However, other types of load-bearing frames or structures may be used as alternatives, with such frames being generally operable to raise and/or lower a payload.

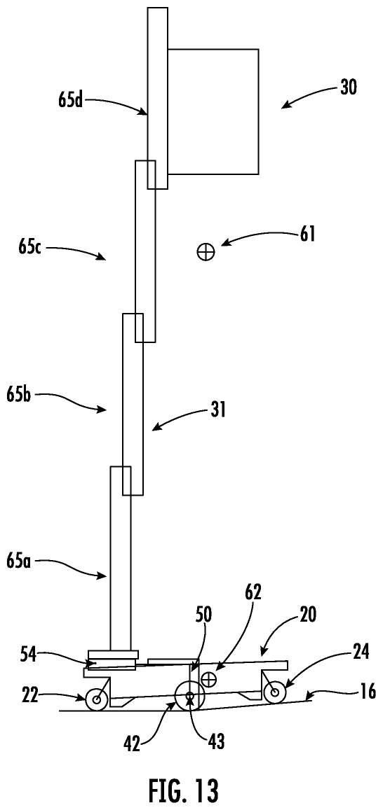

As shown in FIGS. 1 and 13, in this embodiment vertical mast lift mechanism 31 utilizes a series of telescoping upright sections 65a, 6Sb, 65c and 65d, which may be extended in series to raise platform 30 and retracted in series to lower platform 30. Sections 65a, 65b, 65c and 65d are substantially the same in length and are arranged to be telescoped within one another. As shown, bottom primary section 65a is mounted to lever linkage 50, and more particularly to support plate 51 of linkage 50. Three further sections 65b, 65c and 65d are nested within primary section 65a and when extended permit high vertical lifting of platform 30. Load bearing platform 30 is supported on fourth upright section 65d. While a telescoping lift mechanism is shown in this embodiment, other lifting mechanisms may be employed as alternatives, including without limitation a scissor lift mechanism or a pallet jack lift mechanism. In addition, the lift mechanism may be an electric battery-powered lift mechanism. Alternatively, the lift mechanism may be a hydraulic lift mechanism.

Drive system 40 is powered to propel and steer lift 15. As shown, drive system 40 comprises left drive wheel 42 and right drive wheel 41 substantially centered longitudinally 19 in base frame 20 between front caster wheels 21 and 22 and rear caster wheels 23 and 24. Drive wheels 41 and 42 are aligned on and driven to rotate about common drive axis 43. However, drive wheel 41 and drive wheel 42 may be driven separately and independent of each other. Drive wheel 42 is driven by electric motor drive 44 and drive wheel 41 is driven by separate electric motor drive 45. Thus, motor drives 44 and 45 may be controlled to drive wheels 42 and 41 at the same or different speeds and at the same or different rotational directions about drive axis 43 as desired to propel and steer base frame 20. Thus, lift vehicle 15 has a turning radius that is effectively zero when the two substantially centered drive wheels 41 and 42 are driven to rotate at the same speed but in opposite directions. Lift vehicle 15 can be driven to pivot around a point midway laterally 17 between drive wheels 41 and 42, or it can be driven to pivot around either one of drive wheels 41 or 42 if one is held stationary so it does not rotate, or it can be driven to turn in a circle of any radius. Reversal of the direction of travel of lift vehicle 15 can be accomplished by causing both wheels 41 and 42 to rotate in reverse. Accordingly, this configuration allows for, among other things, zero-point turning of lift 15 and better maneuverability in confined spaces.

To provide improved traction of drive wheels 41 and 42 on travel surface 16, including on surfaces in which front castor wheels 21 and 22 and rear caster wheels 23 and 24 are not at the same elevation, lever linkage 50 supporting lift mechanism 31 is longitudinally 19 disposed between carriage 20 and drive wheels 41 and 42. As shown, in this embodiment linkage 50 is connected to carriage 20 at pivot connections 34 and 35 such that linkage 50 is rotatable about pivot axis 54 within a rotational range of motion. Pivot connections 34 and 35 provide for a single degree of rotational freedom of linkage 50 about pivot axis 54 relative to carriage 20. Thus, carriage 20 and its caster wheels 21, 22, 23 and 24 translate laterally 17 and longitudinally 19 on travel surface 16 with translation of drive wheels 41 and 42 on travel surface 16. However, pivot connections 34 and 35 and linkage 50 allows for some variability in the vertical position 39 of drive axis 43 and drive wheels 41 and 42 relative to longitudinal/lateral plane 38 of carriage 20 and support wheels 21, 22, 23 and 24, which allows for improved traction.

In this embodiment, pivot connections 34 and 35 are pin joint connections. Front rail 25 of carriage 20 includes left clevis mount 32 and right clevis mount 33 with clevis pins 55 oriented about pivot axis 54. The front edge 60 of linkage 50 includes corresponding left and right cylindrical openings 56 and 57 orientated about pivot axis 54 that are configured to receive clevis pins 55 of left and right clevis mounts 32 and 33, respectively, such that linkage 50 is pivotally connected to carriage 20 by pin joint connections 34 and 35. Connections 34 and 35 may include cylindrical bearings between openings 56 and 57 and pins 55 of pivot mounts 34 and 35. While connections 34 and 35 comprise pin joint connections in this embodiment, it is contemplated that other various alternative rotational couplings or pivot joints may be employed.

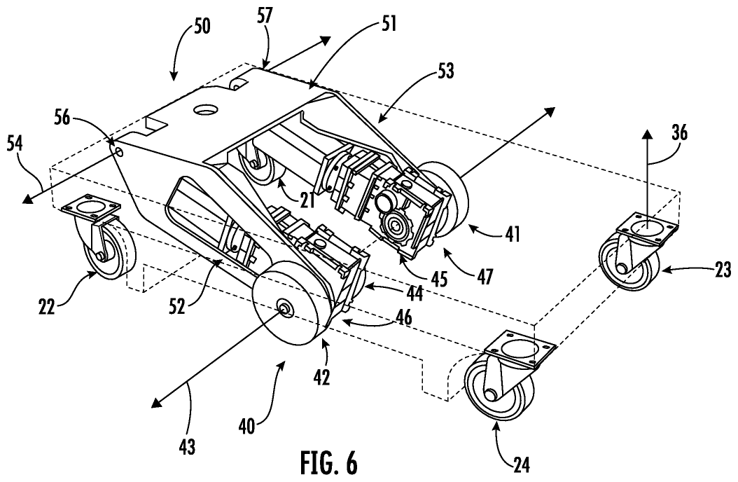

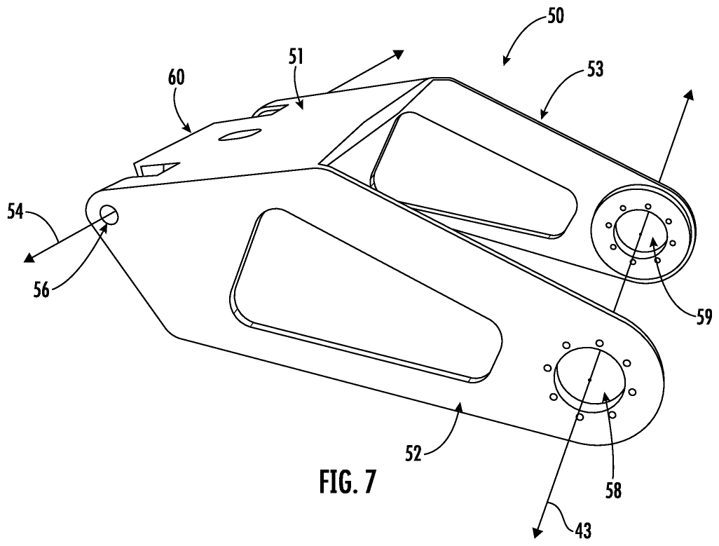

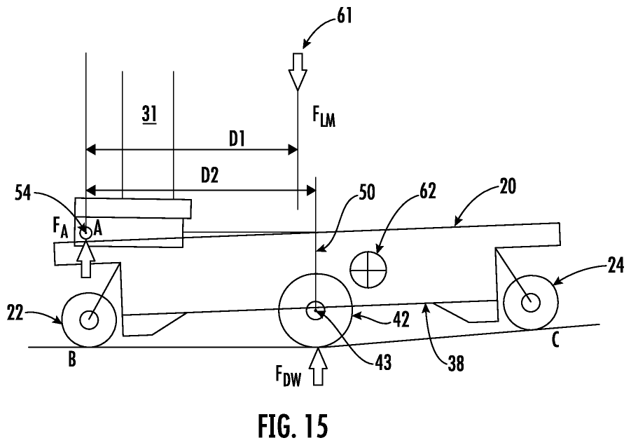

As shown in FIGS. 6 and 7, in this embodiment linkage 50 is a specially configured solid unitary member having a generally planar horizontally-orientated support plate section 51, a left vertically-orientated longitudinally-extending side arm 52, and a right vertically-orientated longitudinally-extending side arm 53 spaced laterally 17 from and orientated parallel to side arm 52. As shown, front laterally extending edge 60 of plate section 51 includes notches to receive clevis mounts 32 and 33 and openings 56 and 57 to receive clevis pins 55. Lift mechanism 31 is mounted to support plate 51 of linkage 50 such that the mass of lift mechanism 31 and platform 30 is supported on top of plate 51 of linkage 50. As shown in FIG. 15, center of mass 61 of lift mechanism 31 and platform 30 is offset distance D1 from pivot axis 54.

As shown, in this embodiment linkage 50 is connected to drive wheels 41 and 42 at drive connections 46 and 47, respectively, such that drive wheels 41 and 42 are rotationally supported by linkage 50. The ends of arms 52 and 53 extend from the left and right edges of support plate 51 toward the center of carriage 20 and have distal ends that terminate near longitudinal/lateral plane 38 of carriage 20. The ends of arms 52 and 53 include openings 58 and 59 orientated about drive axis 43 and support drive wheels 42 and 41, respectively. The drive mechanism of drive wheel 42 is mounted at connection 46 to the inside of left side arm 52 about opening 58 in left side arm 52 and the drive shaft of motor 44 extends through to the outside of opening 58 to drive wheel 42 orientated about drive axis 43. Similarly, the drive mechanism of drive wheel 41 is mounted at connection 47 to the inside of right side arm 53 about opening 59 in right side arm 53 and the drive shaft of motor 45 extends through to the outside of opening 59 to drive wheel 41 orientated about drive axis 43. Thus, drive axis 43 together with drive wheels 41 and 42 are configured to rotate about pivot axis 54 with rotation of linkage 50 about pivot axis 54 relative to carriage 20 and support wheels 21, 22, 23 and 24. A downward force on linkage 50 about pivot axis 54 is transferred at least in part downward on drive wheels 41 and 42.

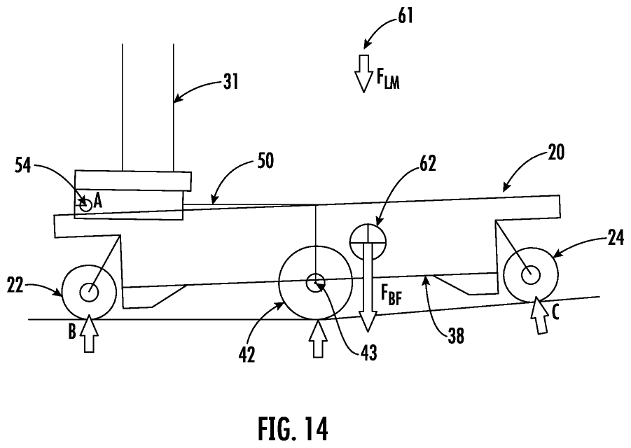

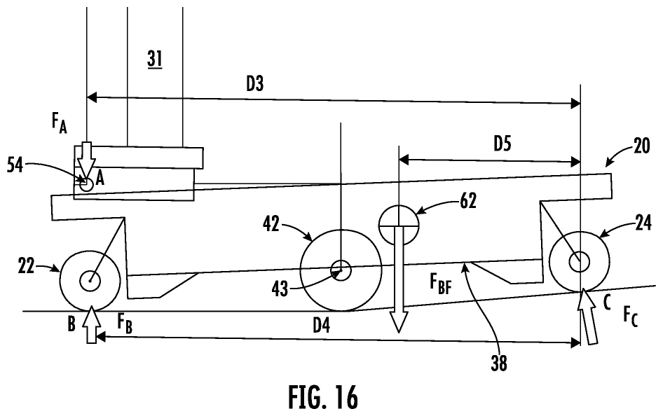

With reference to FIGS. 14 and 15, pivot axis 54 and center of mass 61 of lift mechanism 31 and operator platform 30 on linkage 50 are offset distance D1, resulting in moment F_{LM}D1 about axis 54. The counterforce of travel surface 16 on drive wheels 41 and 42 results in countering moment F_{DW}D2, with D2 being the offset distance between pivot axis 54 and drive axis 43. In this embodiment, distance D1 between center of mass 61 and pivot axis 54 is less than distance D2 between drive axis 43 and pivot axis 54. With reference to FIG. 16, distance D3 is the distance between pivot axis 54 and rear support wheels 23 and 24. Distance D5 is the distance between rear support wheels 23 and center of gravity 62 of base frame 20, including swivel casters 21, 22, 23 and 24, and the other components supported on base frame 20, such as battery and controller. In this embodiment, the distance D3 between rear support wheels 23 and 24 and pivot axis 54 is less than the distance D4 between rear support wheels 23 and 24 and front support wheels 21 and 22.

As shown in FIGS. 8-12, the mass of lift mechanism 31 and platform 30 on swing arm linkage 50 provides a traction force on drive wheels 41 and 42 continuously during operation over ascending and descending sloped travels surfaces. FIGS. 8-12 show vertical movement of drive axis 43 of drive wheels 41 and 42 relative to longitudinal/lateral plane 38 of carriage 20 and support wheels 21, 22, 23 and 24 to maintain a traction force between drive wheels 41 and 42 and travel surface 16 in different travel surface slope transitions. Without the traction force or moment provided by linkage 50, drive wheels 41 and 42 could lose sufficient contact with travel surface 16 when, for example, such travel surface is elevated below support wheels 21, 22, 23 and 24 and is not so elevated below drive wheels 41 and 42.

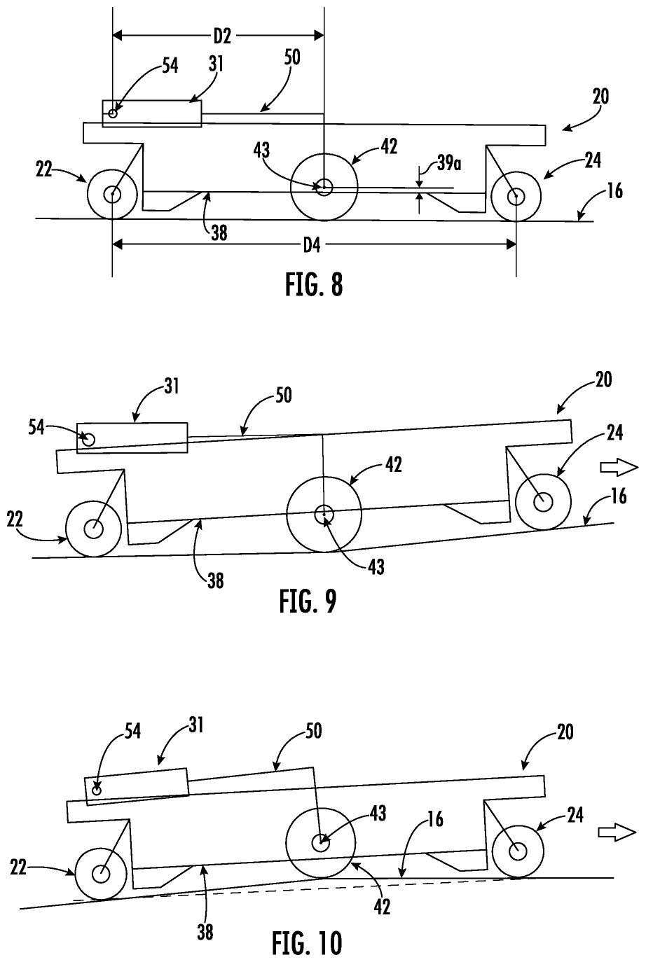

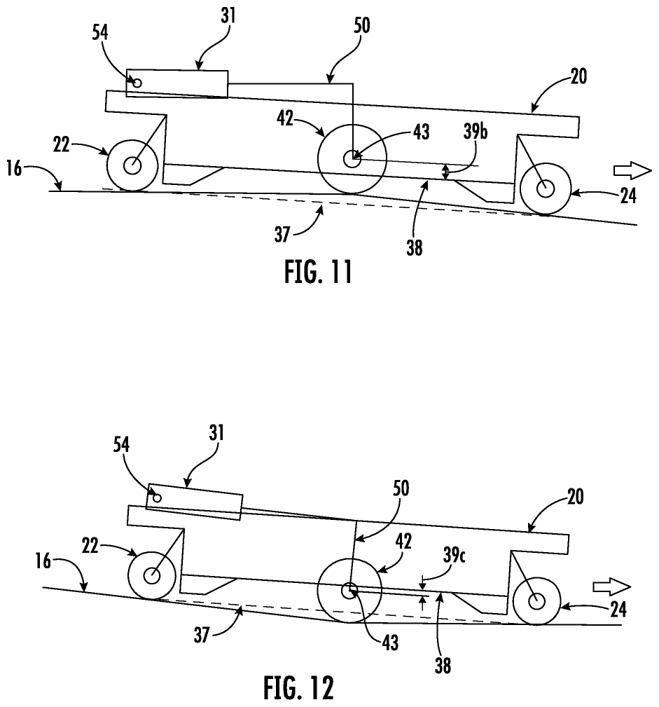

FIG. 8 shows lift vehicle 15 on a flat travel surface across wheel-base span D4 and vertical distance 39a between drive axis 41 and longitudinal/lateral plane 38 of carriage 20 at neutral. In this position, drive wheels 41 and 42 are tangent to plane 37. The application of linkage 50 in maintaining traction force is illustrated in FIGS. 9-12. As shown in FIGS. 10 and 11, drive axis 43 can move to a position above longitudinal/lateral plane 38 of carriage 20 when the slope of travel surface 16 is such that the elevation of travel surface 16 below drive wheels 41 and 42 is higher than the relative summed elevation of travel surface 16 below support wheels 21, 22, 23 and 24. In this position, distance 39b is in a positive range relative to neutral position 39a. In contrast, FIGS. 9 and 12 show drive axis 43 moving to a position at or below longitudinal/lateral plane 38 of carriage 20 when the slope of travel surface 16 is such that the elevation of travel surface 16 below drive wheels 41 and 42 is lower than the relative summed elevation of travel surface 16 below support wheels 21, 22, 23 and 24. In this position, distance 39c is in a negative range relative to neutral position 39a. As shown in FIGS. 9, 12 and 14-16, in this negative range linkage 50 and force F_{LM} provide an improved traction force at drive wheels 41 and 42. Accordingly, the mass of lift mechanism 31 produces a force that keeps drive wheels 41 and 42 in touch with the ground surface 16 on which it is self-propelling and enables lift vehicle 15 to traverse inclination change.

Lift vehicle 15 may include a battery, which may be attached to vehicle frame 20. The battery provides power to all the electronic components that are contained in lift vehicle 15, including drive motors 44 and 45 and lift mechanism 31. In an alternative embodiment, the battery powers some of the components, while others are supplied power by a component's own internal battery. In yet another embodiment, there are two or more batteries provided. The battery may comprise a battery pack. The battery or batteries are in electric communication with the powered components, so as to provide power to them. The mass and location of electronic enclosures, the battery, and any other structural or accessory components on base frame 20 and lift mechanism 31 are coordinated to produce the desired center of mass locations. For example, the battery may be also mounted on support plate 51 of linkage 50 such that the mass of the battery is supported on top of plate 51 of linkage 50 and the center of mass of the battery is offset a distance from pivot axis 54.

In this embodiment, motors 44 and 45 are brushless DC (BLDC) variable-speed drive motors that are supplied with a current. Electric drive motors 44 and 45 are in electrical connection with the battery power source and receive power therefrom. Motors 44 and 45 each comprise a stator fixed to arms 52 and 53 and a rotor that is connected to the drive shaft and driven to rotate about drive axis 43 relative to the stator. In this embodiment, motors 44 and 45 are each a rotary brushless permanent magnet electric motor with the rotor having permanent magnets spaced around its inwardly-facing annular stator-facing surface and the stator having coils energized to drive the rotor and output shaft about motor axis 43 in either rotational direction. When current is appropriately applied through the coils of the stator, a magnetic field is induced. The magnetic field interaction between the stator and rotor generates torque which may rotate the drive shaft. When the supplied current is of one polarity, the motor will rotate in one direction. When the supplied current supplied is of the opposite polarity, the motor will rotate in the opposite direction. Accordingly, motors 44 and 45 selectively apply a torque on their output shaft in one direction about motor axis 43 at varying speeds and apply a torque on their output shaft in the opposite direction about motor axis 43 at varying speeds. Other motors may be used as alternatives. For example, a variable speed stepper motor, brush motor or induction motor may be used.

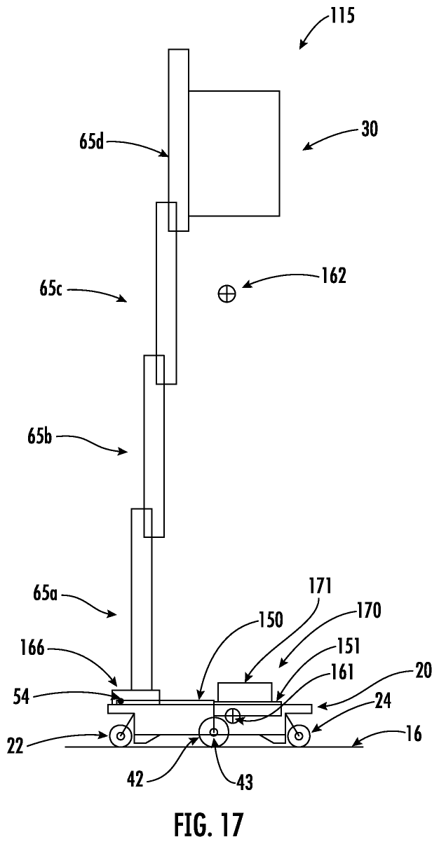

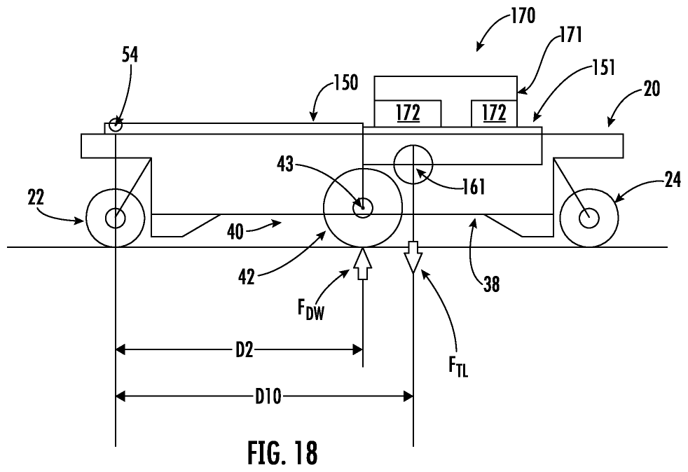

A second embodiment lift vehicle, which is generally indicated at 115, is shown in FIGS. 17 and 18. Lift vehicle 115 is similar to lift vehicle 15 in that lift vehicle 115 comprises vehicle carriage or base frame 20, operator platform 30 configured to support a person or other load, vertical lift mechanism 31 between base frame 20 and platform 30 that is configured to raise and lower platform 30 vertically 18 relative to base frame 20, and drive system 40 configured to propel vehicle 115 on travel surface 16. However, unlike lift vehicle 15, in this embodiment vertical lift mechanism 31 is supported directly by base frame 20 and rigid linkage 150 extends between base frame 20, vehicle components 170 and drive system 40.

As shown in FIG. 17, in this embodiment bottom primary section 65a of vertical lift mechanism 31 is mounted directly to base frame 20, and more particularly to lift plate 166 fixed to left longitudinally-extending side rail 26, right longitudinally-extending side rail 28, and laterally-extending front rail 25 of base frame 20. Operator platform 30 is mounted on telescoping vertical lift mechanism 31 such that lift 115 may be operated to raise or lower an operator relative to carriage 20. Thus, the load of platform 30 and lift mechanism 31 at lift mechanism center of mass 162 is not supported on lever linkage 150 and is instead carried directly by base frame 20.

In this embodiment, to provide improved traction of drive wheels 41 and 42 on travel surface 16, including on surfaces in which front castor wheels 21 and 22 and rear caster wheels 23 and 24 are not at the same elevation, lever linkage 150 of lift vehicle 115 supports other components 170 of vehicle lift 115. In this embodiment, such other components include battery 172, and may also include selected ballast mass 173, contained in housing or enclosure 171 mounted to support plate 151 of lever linkage 150. Battery 172 provides power to electronic components of lift vehicle 115, including drive motors 44 and 45 and lift mechanism 31. Battery 172 may comprise a battery pack in electric communication with the powered components, so as to provide power to them. The mass and location of enclosure 171, battery 172, and ballast 173, together with any other structural or accessory components of lift component 170 on link 150, are coordinated to produce the desired center of mass location 161.

As with linkage 50, in this embodiment linkage 150 is connected to carriage 20 at pivot connections 34 and 35 such that linkage 150 is rotatable about pivot axis 54 within a rotational range of motion. Pivot connections 34 and 35 provide for a single degree of rotational freedom of linkage 150 about pivot axis 54 relative to carriage 20 and pivot connections 34 and 35 and linkage 150 allows for some variability in the vertical position 39 of drive axis 43 and drive wheels 41 and 42 relative to longitudinal/lateral plane 38 of carriage 20 and support wheels 21, 22, 23 and 24, which allows for improved traction. Also as with linkage 50, in this embodiment linkage 150 is connected to drive wheel system 40 such that drive axis 43 together with drive wheels 41 and 42 are configured to rotate about pivot axis 54 with rotation of linkage 150 about pivot axis 54 relative to carriage 20 and support wheels 21, 22, 23 and 24. A downward force on linkage 150 about pivot axis 54 is transferred at least in part downward on drive wheels 41 and 42. However, unlike linkage 50, in this embodiment linkage 150 has a rearwardly orientated support plate 151, which is positioned longitudinally 19 behind drive wheel axis 43. Component housing 171 with components 170 are mounted to support plate 151 of linkage 150 such that the mass of components 170 is supported on top of plate 151 of linkage 150 and at a greater longitudinal distance from pivot axis 54 than drive axis 43. As shown in FIG. 18, center of mass 161 of components 170 is offset distance D10 from pivot axis 54.

With reference to FIG. 18, pivot axis 54 and center of mass 161 of components 170 on linkage 150 are offset distance D10, resulting in moment F_{TL}D10 about axis 54. The counterforce of travel surface 16 on drive wheels 41 and 42 results in countering moment F_{DW}D2, with D2 being the offset distance between pivot axis 54 and drive axis 43. In this embodiment, distance D10 between center of mass 161 and pivot axis 54 is greater than distance D2 between drive axis 43 and pivot axis 54.

The mass of lift components 170 on swing arm linkage 150 provides a traction force on drive wheels 41 and 42 continuously during operation over ascending and descending sloped travels surfaces. Without the traction force or moment provided by linkage 150, drive wheels 41 and 42 could lose sufficient contact with travel surface 16 when, for example, such travel surface is elevated below support wheels 21, 22, 23 and 24 and is not so elevated below drive wheels 41 and 42.

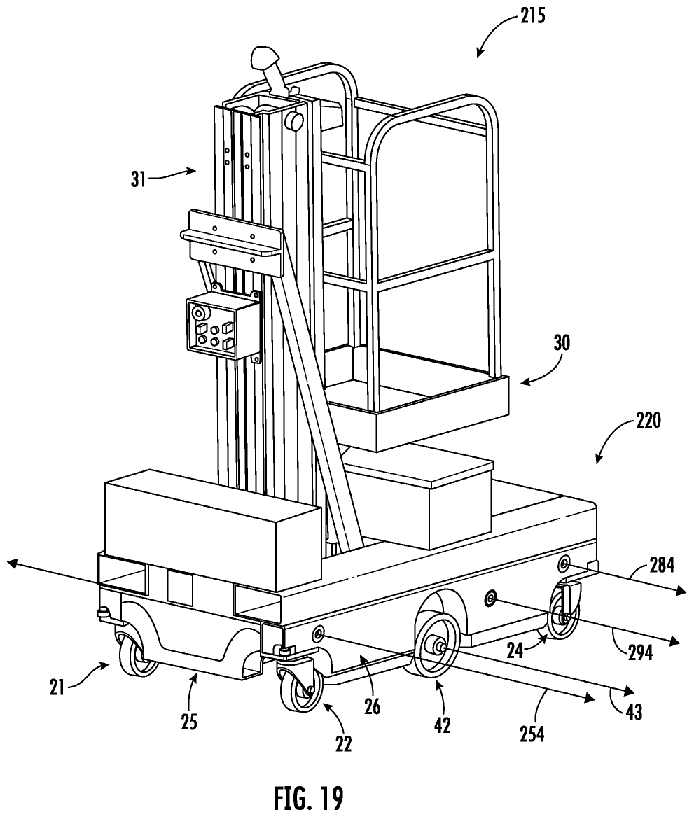

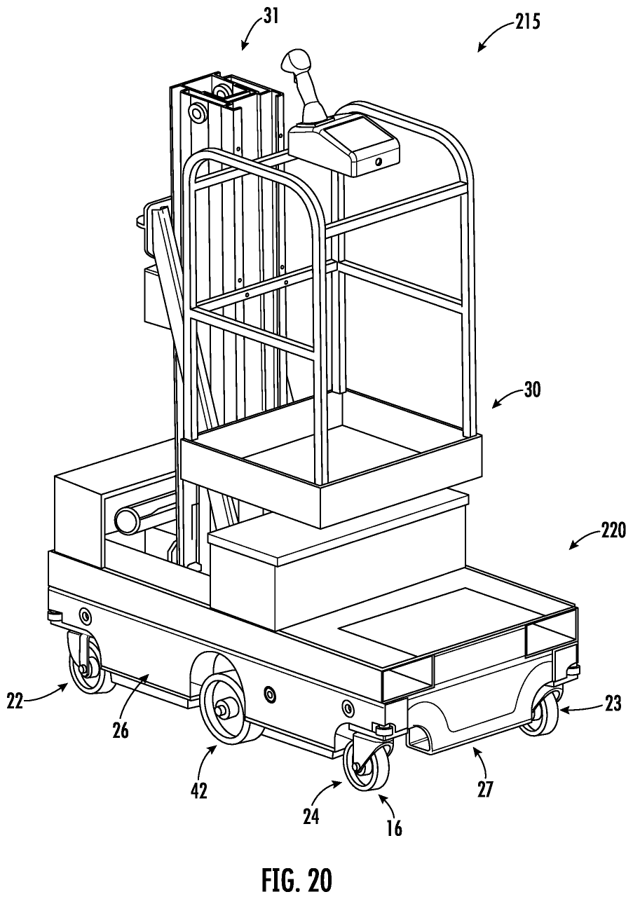

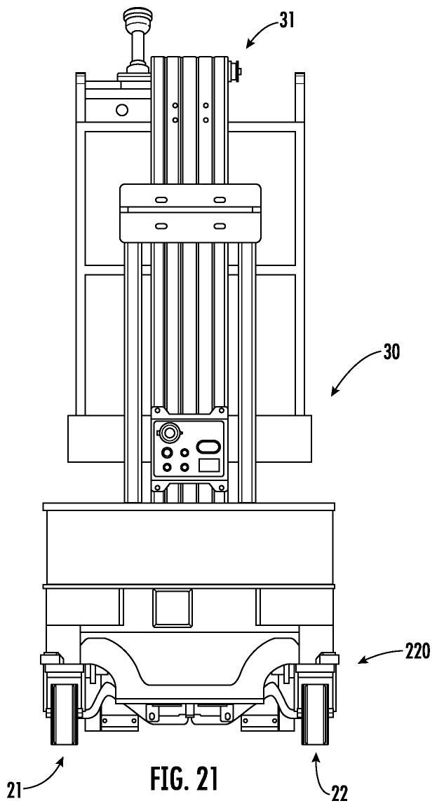

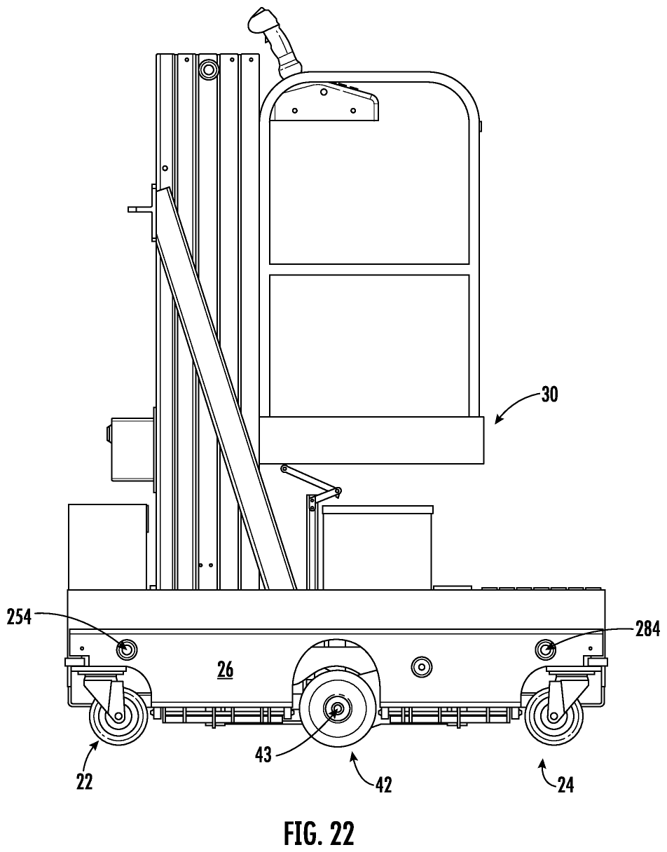

A third embodiment lift vehicle, which is generally indicated at 215, is shown in FIGS. 19-26. Lift vehicle 215 is similar to lift vehicle 15 in that lift vehicle 215 comprises vehicle carriage or base frame 220, operator platform 30 configured to support a person or other load, vertical lift mechanism 31 between base frame 220 and platform 30 that is configured to raise and lower platform 30 vertically 18 relative to base frame 220, and drive system 40 configured to propel vehicle 215 on travel surface 16. However, unlike lift vehicle 15, in this embodiment a multi-link and multi-pivot linkage 250 extends between base frame 220, vertical lift mechanism 31 and drive system 40.

As with lift vehicle 15, vehicle base frame or carriage 220 is generally formed by left longitudinally-extending side rail 26, right longitudinally-extending side rail 28, laterally-extending front rail 25, laterally-extending rear rail 27, left front castor wheel 22, right front castor wheel 21, left rear castor wheel 24, and right rear castor wheel 23.

As with lift vehicle 15, operator platform 30 is mounted on telescoping vertical lift mechanism 31 and includes a basket and an operator controller and is configured to support a person such that lift 15 may be operated to raise or lower the operator relative to carriage 220. As with lift vehicle 15, vertical mast lift mechanism 31 utilizes a series of telescoping upright sections, which may be extended in series to raise platform 30 and retracted in series to lower platform 30, with the bottom primary section mounted to lever linkage 250, and more particularly to support link 251 of linkage 250, and the top section supporting load bearing platform 30.

As with lift vehicle 15, drive system 40 is powered to propel and steer lift 215 and comprises left and right drive wheels 42 and 41 aligned on and driven separately and independent of each other to rotate about common drive axis 43 by electric motor drives 44 and 45, respectively.

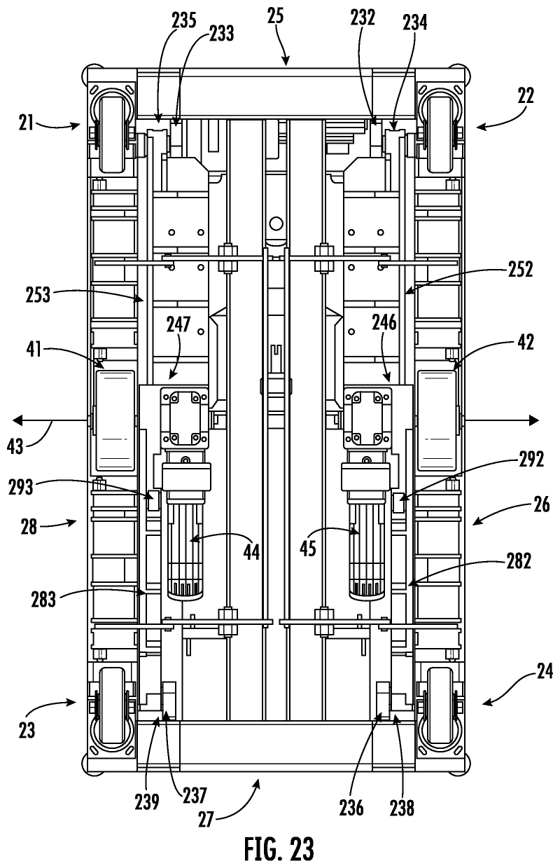

In this embodiment, to provide improved traction of drive wheels 41 and 42 on travel surface 16, including on surfaces in which front castor wheels 21 and 22 and rear caster wheels 23 and 24 are not at the same elevation, multi-link and multi-pivot linkage 250 supporting lift mechanism 31 is longitudinally 19 disposed between carriage 220 and drive wheels 41 and 42. As shown in FIGS. 23-26, in this embodiment linkage 250 generally comprises support link 251 having left and right parallel support link arms 252 and 253, and traction link 281 having left and right parallel traction link arms 282 and 283. While lift vehicles 15 and 115 provide a single load-supporting linkage 50 and 150, respectively, coupled between drive wheels 41 and 42 at drive axis 43 and carriage 20 at a single offset pivot axis 54, in this embodiment vehicle 215 has a multi-link and multi-pivot linkage 250 comprising coupled support link 251 and traction link 281, with support link 251 coupled between traction link 281 at linking low friction translating axis 294 and carriage 220 at first offset pivot axis 254, and with traction link 281 coupled between drive wheels 41 and 42 at drive axis 43 and carriage 220 at second offset pivot axis 284.

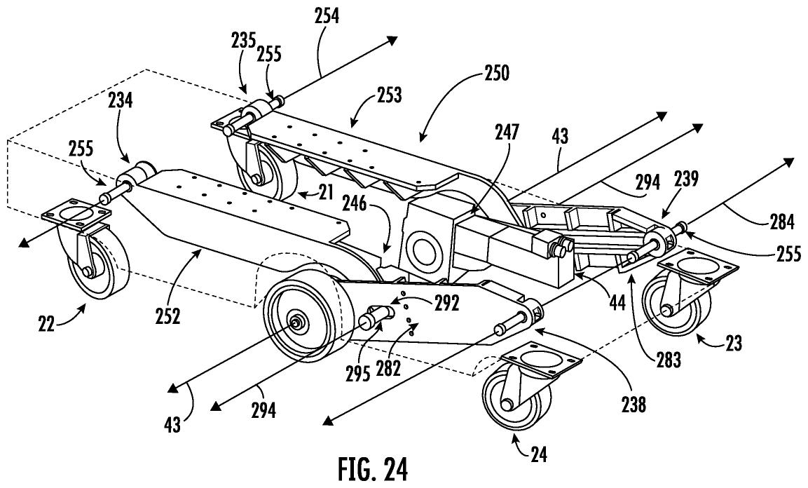

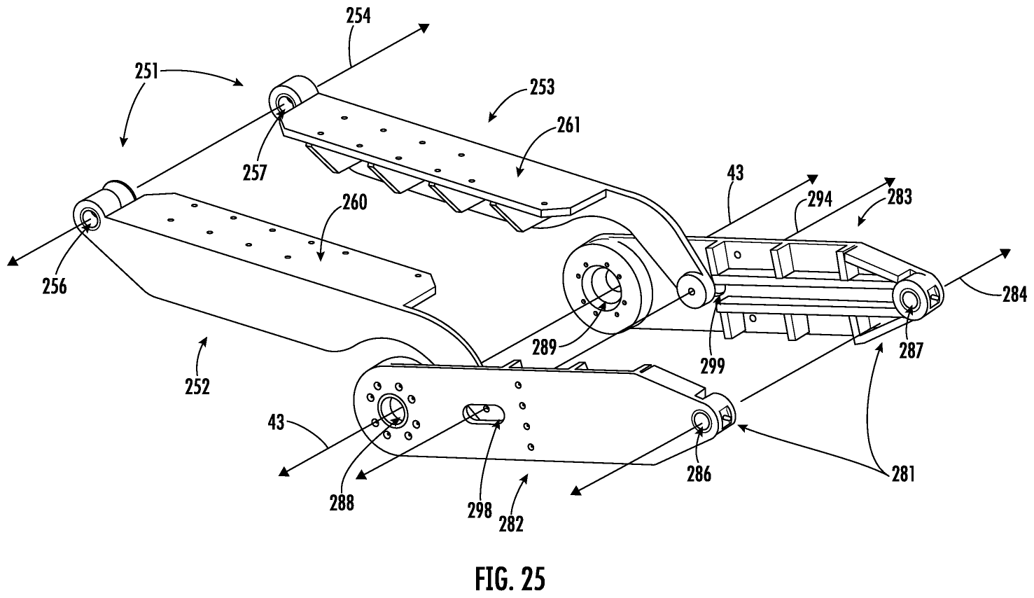

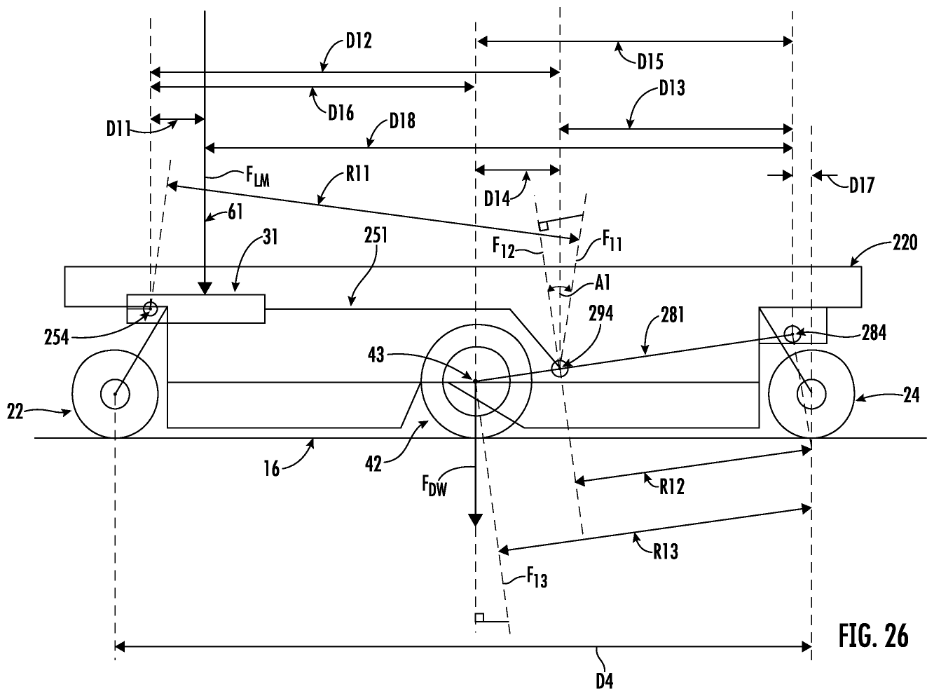

In this embodiment, link arms 252 and 253 of support link 251 are each connected to the front of carriage 220 at pivot connections 234 and 235, respectively, such that support link 251 is rotatable about pivot axis 254 within a rotational range of motion. Pivot connections 234 and 235 provide for a single degree of rotational freedom of support link 251 about pivot axis 254 relative to carriage 220. In this embodiment, pivot connections 234 and 235 are pin joint connections. Front rail 25 of carriage 220 includes left clevis mount 232 and right clevis mount 233 with clevis pins 255 oriented about pivot axis 254. As shown in FIGS. 24 and 25, in this embodiment left longitudinally-extending side link arm 252 is a specially configured solid unitary member having a generally planar horizontally-orientated section 260 and right longitudinally-extending side link arm 253 is spaced laterally 17 from and orientated parallel to side link arm 252 and is also a specially configured solid unitary member having a generally planar horizontally-orientated section 261. As shown, the first ends of arms 252 and 253 include cylindrical openings 256 and 257 orientated about pivot axis 254 that receive clevis pins 255 of left and right clevis mounts 232 and 233, respectively, such that linkage 251 is pivotally connected to carriage 220 by pin joint connections 234 and 235. Connections 234 and 235 may include cylindrical bearings between openings 256 and 257 and pins 255 of pivot mounts 234 and 235. Lift mechanism 31 is mounted to sections 260 and 261 of link arms 252 and 253 of support link 251 such that the mass of lift mechanism 31 and platform 30 is supported on top of support link 251. As shown in FIG. 26, center of mass 61 of lift mechanism 31 and platform 30 is offset distance D11 from pivot axis 254.

In this embodiment, link arms 282 and 283 of traction link 281 are each connected to the rear of carriage 220 at pivot connections 238 and 239, respectively, such that traction link 281 is rotatable about pivot axis 284 within a rotational range of motion. Pivot connections 238 and 239 provide for a single degree of rotational freedom of traction link 281 about pivot axis 284 relative to carriage 220. In this embodiment, pivot connections 238 and 239 are pin joint connections. Rear rail 27 of carriage 220 includes left clevis mount 236 and right clevis mount 237 with clevis pins 255 oriented about pivot axis 284. As shown in FIGS. 24 and 25, in this embodiment left longitudinally-extending side link arm 282 is a specially configured solid unitary member and right longitudinally-extending side link arm 283 is spaced laterally 17 from and orientated parallel to side link arm 282 and is also a specially configured solid unitary member. As shown, the first ends of arms 282 and 283 include cylindrical openings 286 and 287 orientated about pivot axis 284 that receive clevis pins 255 of left and right clevis mounts 236 and 237, respectively, such that linkage 281 is pivotally connected to carriage 220 by pin joint connections 238 and 239. Connections 238 and 239 may include cylindrical bearings between openings 286 and 287 and pins 255 of pivot mounts 236 and 237.

As shown, in this embodiment traction link 281 is connected to drive wheels 41 and 42 at drive connections 246 and 247, respectively, such that drive wheels 41 and 42 are rotationally supported by arms 282 and 283 of traction link 281, respectively. The second ends of arms 282 and 283 extend toward the center of carriage 20 and have distal ends that terminate near longitudinal/lateral plane 38 of carriage 20. The ends of arms 282 and 283 include openings 288 and 289 orientated about drive axis 43 and support drive wheels 42 and 12, respectively. The drive mechanism of drive wheel 42 is mounted at connection 246 to the inside of left side arm 282 about opening 288 in left side arm 282 and the drive shaft of motor 244 extends through to the outside of opening 288 to drive wheel 41 orientated about drive axis 43. Similarly, the drive mechanism of drive wheel 41 is mounted at connection 247 to the inside of right side arm 283 about opening 289 in right side arm 283 and the drive shaft of motor 45 extends through to the outside of opening 289 to drive wheel 41 orientated about drive axis 43. Thus, drive axis 43 together with drive wheels 41 and 42 are configured to rotate about pivot axis 284 with rotation of traction link 281 about pivot axis 284 relative to carriage 220 and support wheels 21, 22, 23 and 24. As shown in FIG. 26, drive axis 43 is offset distance D15 from pivot axis 284 and drive axis 43 is offset distance D16 from pivot axis 254.

In this embodiment, link arms 252 and 253 of support link 251 are also each connected to traction arms 282 and 283 of traction link 281 at roller connections 292 and 293 between pivot axis 284 and drive axis 43 of traction link 281, respectively, such that support link 251 is in rotatable and low friction translating engagement with traction link 281 at linking axis 294 within a linear and rotational range of motion. In this embodiment, rolling pivot connections 292 and 293 are roller joint connections. As shown, traction arms 282 and 283 of traction link 281 include open roller tracks 298 and 299 that receive roller bearings 295 on the second distal ends of link arms 252 and 253 of support link 251, respectively. As shown in FIG. 26, linking axis 294 is offset variable distance D12 from pivot axis 254 and linking axis 294 is offset variable distance D13 from pivot axis 284. As shown in FIG. 26, linking axis 294 is offset variable distance D14 from drive axis 43. In this embodiment, D12 is greater than D16 and D13 is less than D15.

With reference to FIG. 26, center of mass 61 of lift mechanism 31 and operator platform 30 on linkage 251 is offset distance D11 from pivot axis 254, resulting in moment F_{LM}D11 about axis 254. The resulting force F11 on linkage 251 at offset distance R11 results in moment F₁₁R11 about axis 254. The resulting force F₁₂ on linkage 281 at offset distance R12 results in moment F₁₂R12 about axis 284, with F₁₂ being the function of the cosine of angle A1 and F₁₁. The resulting force F₁₃ on linkage 281 at offset distance R13 results in moment F₁₃R13 about axis 284 and the resulting drive wheel force F_{DW} of drive wheels 41 and 42 on surface 16 is the function of the cosine of angle A2 and F₁₂. Accordingly, downward force on support link 251 clockwise about pivot axis 254 is transferred at least in part downward on traction link about pivot axis 284, and the downward force on traction link 281 about axis 284 is transferred downward on drive wheels 41 and 42. Thus, carriage 220 and its caster wheels 21, 22, 23 and 24 translate laterally 17 and longitudinally 19 on travel surface 16 with translation of drive wheels 41 and 42 on travel surface 16. Linkage 250 allows for some variability in the vertical position 39 of drive axis 43 and drive wheels 41 and 42 relative to longitudinal/lateral plane 38 of carriage 220 and support wheels 21, 22, 23 and 24, which allows for improved traction, while also reducing the angle of movement of platform 30 relative to ground 16 as mast lift 215 traverses inclinations of ground 16. The mass of lift mechanism 31 and platform 30 on swing arm linkage 250 thereby provides a traction force on drive wheels 41 and 42 continuously during operation over ascending and descending sloped travels surfaces. Without the traction force or moment provided by linkage 250, drive wheels 41 and 42 could lose sufficient contact with travel surface 16 when, for example, such travel surface is elevated below support wheels 21, 22, 23 and 24 and is not so elevated below drive wheels 41 and 42.

Lift vehicles 15, 115 and 215 provide a number of advantages, including providing positive contact between drive wheels 41 and 42 and travel surface 16 with adequate contact pressure for traction, providing smooth transition in to and out of ascending and descending slopes of six degrees or less, and improved traction torque capacity of drive wheels 41 and 42.

It should be appreciated that certain features of the system, which are, for clarity, described in the context of separate embodiments, may also be provided in combination in a single embodiment. Conversely, various features, which are, for brevity, described in the context of a single embodiment, may also be provided separately or in any suitable combination. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. A lift vehicle comprising:
a carriage;
a drive wheel system operatively configured to propel said carriage;
said drive wheel system comprising at least a first drive wheel orientated about a drive axis and operatively configured to rotate about said drive axis relative to said carriage;
a load carrying frame;
a lift structure connected to and supporting said load carrying frame and operatively configured to raise and lower said load carrying frame vertically relative to said carriage;
a lever linkage connected to and supporting a traction load component of said lift vehicle;
said lever linkage coupled to said carriage at a pivot connection and operatively configured to rotate about a pivot axis relative to said carriage;
said lever linkage coupled to said first drive wheel at a first drive wheel connection;
said pivot axis offset from said drive axis by a pivot-to-drive offset distance;
said traction load component supported by said lever linkage a pivot-to-load offset distance from said pivot axis; and
said drive axis operatively configured to rotate relative to said carriage about said pivot axis to engage a travel surface.

2. The lift vehicle set forth in claim 1, wherein:
said drive system comprises a second drive wheel orientated about said drive axis;
said lever linkage is coupled to said second drive wheel at a second drive wheel connection;
said first drive wheel is driven by a first traction drive;
said second drive wheel is driven by a second traction drive;
said first and second drive wheels are operatively configured to be driven independently of each other by said first and second traction drives, respectively; and
said drive wheel system is operatively configured to steer said carriage.

3. (canceled)

4. The lift vehicle set forth in claim 2, wherein:
said carriage comprises a plurality of unpowered support wheels;
said plurality of unpowered support wheels comprise first and second front support wheels laterally offset from each other relative to said carriage and first and second rear support wheels laterally offset from each other relative to said carriage;
said first and second front support wheels are longitudinally offset from said first and second rear support wheels relative to said carriage; and
said drive axis of said first and second drive wheels is disposed longitudinally between said first and second front support wheels and said first and second rear support wheels relative to said carriage.

5. (canceled)

6. (canceled)

7. (canceled)

8. The lift vehicle set forth in claim 4, wherein each of said plurality of support wheels comprises a caster orientated about a swivel axis and operatively configured to rotate about said swivel axis relative to said carriage and said swivel axis is perpendicular to said drive axis.

9. (canceled)

10. The lift vehicle set forth in claim 1, wherein:
said pivot connection comprises a first pin joint connection having a first clevis pin, said carriage comprises a first clevis, said lever linkage comprises a first pin opening configured to receive said first clevis pin, and said first clevis pin is orientated about said pivot axis and extends between said first clevis of said carriage and said first pin opening of said lever linkage, such that said lever linkage is rotationally connected about said pivot axis to said carriage by said first pin joint connection; and
said pivot connection comprises a second pin joint connection having a second clevis pin, said carriage comprises a second clevis, said lever linkage comprises a second pin opening configured to receive said second clevis pin, and said second clevis pin is orientated about said pivot axis and extends between said second clevis of said carriage and said second pin opening of said lever linkage, such that said lever linkage is rotationally connected about said pivot axis to said carriage by said second pin joint connection.

11. (canceled)

12. The lift vehicle set forth in claim 1, wherein said lever linkage comprises a solid unitary member having a deck plate supporting said traction load component.

13. The lift vehicle set forth in claim 1, wherein said lever linkage comprises:
a first link coupled to said carriage at said pivot connection and operatively configured to rotate about said pivot axis relative to said carriage;
said first linkage coupled to said first drive wheel at said first drive wheel connection;
a second link supporting said traction load component of said lift vehicle;
said second link coupled to said carriage at a second pivot connection and operatively configured to rotate about a second pivot axis relative to said carriage;
said second link coupled to said first link at a link connection;
said second pivot axis offset from said drive axis by a second pivot-to-drive offset distance;
said traction load component supported by said first link a second pivot-to-load offset distance from said second pivot axis; and
wherein a traction part of said traction load component is operatively transferred from said second link to said first link via said link connection.

14. The lift vehicle set forth in claim 13, wherein said link connection comprises a low friction motion translating connection operatively configured to transfer said traction part of said traction load component from said second link to said first link.

15. The lift vehicle set forth in claim 13, wherein:
said first link comprises separate first and second traction link arms;
said pivot connection comprises first and second traction pivot connections; and
said first and second traction link arms are coupled to said carriage at said first and second traction pivot connections, respectively, and are operatively configured to rotate about said pivot axis relative to said carriage.

16. The lift vehicle set forth in claim 15, wherein:
said second link comprises separate first and second support link arms;
said second pivot connection comprises first and second support pivot connections; and
said first and second support link arms are coupled to said carriage at said first and second support pivot connections, respectively, and are operatively configured to rotate about said second pivot axis relative to said carriage.

17. The lift vehicle set forth in claim 16, wherein:
said first and second traction pivot connections comprise first and second traction pin joint connections having first and second traction clevis pins, respectively;
said carriage comprises first and second traction clevises;
said first and second traction link arms comprise first and second traction pin openings configured to receive said first and second traction clevis pins, respectively;
said first and second traction clevis pins are orientated about said pivot axis and extend between said first and second traction clevises of said carriage and said first and second traction pin openings of said first and second traction link arms, respectively, such that said first link is rotationally connected about said pivot axis to said carriage by said first and second traction pin joint connections;
said first and second support pivot connections comprise first and second support pin joint connections having first and second support clevis pins, respectively;
said carriage comprises first and second support clevises;
said first and second support link arms comprise first and second support pin openings configured to receive said first and second support clevis pins, respectively; and
said first and second support clevis pins are orientated about said second pivot axis and extend between said first and second support clevises of said carriage and said first and second support pin openings of said first and second support link arms, respectively, such that said second link is rotationally connected about said second pivot axis to said carriage by said first and second support pin joint connections.

18. The lift vehicle set forth in claim 15, wherein:
said first drive wheel comprises a first drive shaft, said first traction link arm comprises a first drive shaft opening configured to receive said first drive shaft, and said first drive shaft is orientated about said drive axis and extends between said first drive wheel and said first drive shaft opening of said first traction link arm, such that said first drive wheel is rotationally connected about said drive axis to said first traction link arm by said first drive wheel connection; and
said drive system comprises a second drive wheel orientated about said drive axis, said second traction link arm is coupled to said second drive wheel at a second drive wheel connection, said second drive wheel comprises a second drive shaft, said second traction link arm comprises a second drive shaft opening configured to receive said second drive shaft, and said second drive shaft is orientated about said drive axis and extends between said second drive wheel and said second drive shaft opening of said second traction link arm, such that said second drive wheel is rotationally connected about said drive axis to said second traction link arm by said second drive wheel connection.

19. The lift vehicle set forth in claim 18, wherein said first drive wheel is driven by a first traction drive supported by said first traction link arm, said second drive wheel is driven by a second traction drive supported by said second traction link arm, said first and second drive wheels are operatively configured to be driven independently of each other by said first and second traction drives, respectively, and said drive wheel system is operatively configured to steer said carriage via said lever linkage.

20. The lift vehicle set forth in claim 1, wherein:
said first drive wheel comprises a first drive shaft, said lever linkage comprises a first drive shaft opening configured to receive said first drive shaft, and said first drive shaft is orientated about said drive axis and extends between said first drive wheel and said first drive shaft opening of said lever linkage, such that said first drive wheel is rotationally connected about said drive axis to said lever linkage by said first drive wheel connection; and
said drive system comprises a second drive wheel orientated about said drive axis, said lever linkage is coupled to said second drive wheel at a second drive wheel connection, said second drive wheel comprises a second drive shaft, said lever linkage comprises a second drive shaft opening configured to receive said second drive shaft, and said second drive shaft is orientated about said drive axis and extends between said second drive wheel and said second drive shaft opening of said lever linkage, such that said second drive wheel is rotationally connected about said drive axis to said lever linkage by said second drive wheel connection.

21. The lift vehicle set forth in claim 20, wherein said first drive wheel is driven by a first traction drive supported by said lever linkage, said second drive wheel is driven by a second traction drive supported by said lever linkage, said first and second drive wheels are operatively configured to be driven independently of each other by said first and second traction drives, respectively, and said drive wheel system is operatively configured to steer said carriage via said lever linkage.

22. The lift vehicle set forth in claim 1, wherein:
said carriage comprises a plurality of unpowered support wheels;
said plurality of unpowered support wheels comprise first and second front support wheels laterally offset from each other relative to said carriage and first and second rear support wheels laterally offset from each other relative to said carriage;
said first and second front support wheels are longitudinally offset from said first and second rear support wheels relative to said carriage by a longitudinal support wheel base distance relative to said carriage;
said drive axis of said first drive wheel is disposed longitudinally between said first and second front support wheels and said first and second rear support wheels relative to said carriage; and
said pivot axis is offset from said first and second rear support wheels by a longitudinal pivot-to-rear offset distance relative to said carriage.

23. The lift vehicle set forth in claim 22, wherein said pivot-to-rear offset distance is less than said support wheel base distance.

24. The lift vehicle set forth in claim 1, wherein said traction load component has a traction center of mass and said traction center of mass is offset from said pivot axis said pivot-to-load offset distance, and said pivot-to-load offset distance is less than or greater than said pivot-to-drive offset distance.

25. (canceled)

26. (canceled)

27. The lift vehicle set forth in claim 1, wherein said traction load component comprises said lift structure and said lever linkage comprises a solid unitary member having a deck plate supporting said lift structure.

28. The lift vehicle set forth in claim 1, wherein said traction load component comprises a battery and said lever linkage comprises a battery housing supporting said battery, or wherein said traction load component comprises a ballast mass and said lever linkage comprises a ballast retainer supporting said ballast mass.

29. (canceled)

30. The lift vehicle set forth in claim 1, wherein said lift structure comprises a telescoping lift mechanism and said load carrying frame comprises an operator platform.

31. The lift vehicle set forth in claim 1, comprising a battery supported by said carriage and wherein said lift structure comprises an all-electric battery-powered lift mechanism.

32. The lift vehicle set forth in claim 21, comprising a battery supported by said carriage and wherein each of said first traction drive and said second traction drive comprise an electric battery-powered motor.

33. The lift vehicle set forth in claim 1, wherein said lift structure is selected from a group consisting of a hydraulic lift mechanism, a telescoping lift mechanism, a jack lift mechanism, and a scissor lift mechanism.

34. (canceled)
